(19) United States
(12) Patent Application Publication
(10) Pub. No.: US 2025/0214468 A1
(43) Pub. Date: Jul. 3, 2025

(54) VEHICLE COOLING SYSTEM

(71) Applicant: YAZAKI CORPORATION, Tokyo (JP)

(72) Inventors: Takahiko Katsuramaki, Makinohara-shi (JP); Taku Furuta, Makinohara-shi (JP)

(21) Appl. No.: 19/087,424

(22) Filed: Mar. 21, 2025

Related U.S. Application Data
(63) Continuation of application No. PCT/JP2023/046642, filed on Dec. 26, 2023.

(30) Foreign Application Priority Data
Jan. 31, 2023 (JP) 2023-013268

(51) Int. Cl. B60L 53/302; B60L 53/18; H01B 7/42

(52) U.S. Cl. CPC B60L 53/302; B60L 53/18; H01B 7/423

(57) ABSTRACT

A vehicle cooling system includes a cable including an electric wire and two refrigerant flow passages that extend along the electric wire and that are for cooling the electric wire by a refrigerant flowing through an inside of the two refrigerant flow passages, and a female connector that is attached to an end portion of the cable and that is fitted and connected to a counterpart male connector mounted on a vehicle. The female connector is provided with a U-turn connection flow path that causes, by causing the two refrigerant flow passages of the cable to communicate with each other, the refrigerant flowing through one of the two refrigerant flow passages to flow into the other.

### CROSS-REFERENCE TO RELATED APPLICATIONS

This is a continuation of International Application No. PCT/JP2023/046642 filed on Dec. 26, 2023, and claims priority from Japanese Patent Application No. 2023-013268 filed on Jan. 31, 2023, the entire content of which is incorporated herein by reference.

### TECHNICAL FIELD

The present disclosure relates to a vehicle cooling system for an electric vehicle and the like.

### BACKGROUND ART

With an increase in the output of an electric vehicle and the like, a conductive path that can withstand a high voltage and a high current has been required. When the voltage and the current become higher, an increase in the amount of heat generated in the conductive path becomes a problem, and thus it is necessary to increase the diameter of a cable such as a charging cable and a motor cable. However, when the diameter of the cable is increased, a problem of an increase in the weight and a problem of an increase in the mounting space occur, and thus there is a growing demand to prevent the increase in the diameter.

Patent Literature 1 discloses a technique for cooling a terminal by flowing a refrigerant through a fluid passage that is formed inside the terminal. However, since the cable is not cooled, it is difficult to prevent an increase in the diameter of the cable.

### CITATION LIST

### Patent Literature

Patent Literature 1: WO2021/106958

### SUMMARY OF INVENTION

In the technique described above, since the cable in the vehicle is not cooled and it is difficult to prevent an increase in the diameter of the cable, the problem of an increase in the weight of the cable and the problem of an increase in the mounting space may occur.

The present disclosure has been made in view of the circumstances described above, and an object of the present disclosure is to provide a vehicle cooling system capable of minimizing an increase in the diameter of a cable associated with an increase in the output of an electric vehicle.

In order to achieve the above object, the vehicle cooling system according to the present disclosure has the following features.

A vehicle cooling system including:
a cable including an electric wire and two refrigerant flow passages that extend along the electric wire and that are for cooling the electric wire by a refrigerant flowing through an inside of the two refrigerant flow passages; and
a connector that is attached to an end portion of the cable and that is fitted and connected to a counterpart connector mounted on a vehicle,
in which the connector is provided with a connection flow path that causes, by causing the two refrigerant flow passages of the cable to communicate with each other, the refrigerant flowing through one of the two refrigerant flow passages to flow into the other, and
a cable side refrigerant passage that is implemented by the two refrigerant flow passages in the cable and the connection flow path in the connector is arranged inside the vehicle.

According to the present disclosure, it is possible to minimize an increase in the diameter of a cable associated with an increase in the output of an electric vehicle.

The present disclosure has been briefly described above. Further, the details of the present disclosure can be clarified by reading a mode (hereinafter, referred to as an “embodiment”) for carrying out the invention to be described below with reference to the accompanying drawings.

### BRIEF DESCRIPTION OF DRAWINGS

FIG. 1 is a schematic diagram showing a schematic configuration of a first embodiment of the present disclosure;

FIG. 2 is a perspective view showing a relationship among the end portion of a cable, a connector that is attached to the end portion, and a counterpart connector to which the connector is fitted and connected in the embodiment;

FIG. 3 is an exploded perspective view showing a specific example of the connector;

FIG. 4 is a schematic diagram showing a schematic configuration of a second embodiment of the present disclosure; and

FIG. 5 is a schematic diagram showing a schematic configuration of a third embodiment of the present disclosure.

### DESCRIPTION OF EMBODIMENTS

Specific embodiments of the present disclosure will be described below with reference to the drawings.

### First Embodiment

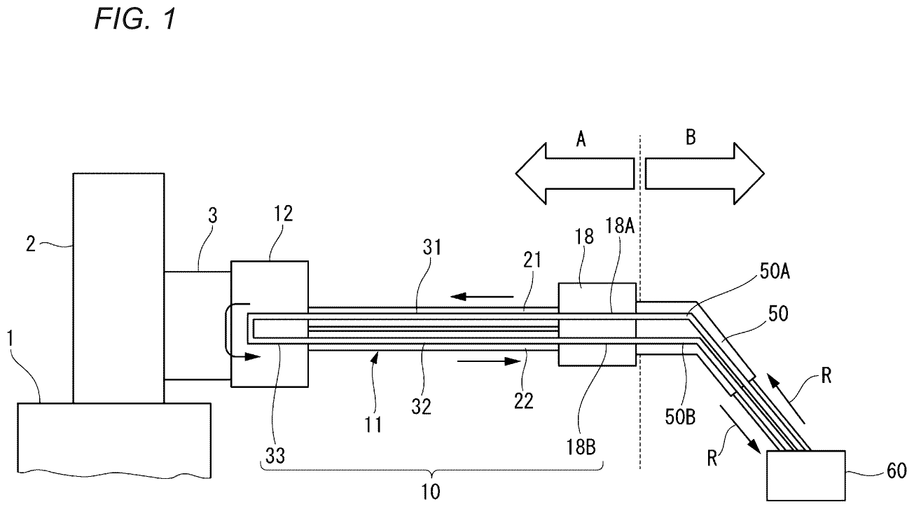

FIG. 1 shows a schematic configuration of a vehicle cooling system according to a first embodiment of the present disclosure.

In FIG. 1, a region A on the left side divided by the dotted line shows the configuration inside the electric vehicle, and a region B on the right side shows the configuration (the configuration on the infrastructure side) of a charging facility outside the vehicle.

As the charging facility outside the vehicle (the region B), a charging connector 50 that is connected to a power supply device (not shown) is prepared. The charging connector 50 is attached to the distal end of a charging cable (not shown). The charging connector 50 is provided with a refrigerant inflow passage 50A and a refrigerant outflow passage 50B in addition to a pair of positive and negative charging terminals (not shown).

The refrigerant inflow passage 50A of the charging connector 50 is connected to the refrigerant discharge port of a refrigerant circulation pump 60 on the infrastructure side via a refrigerant pipe that is provided together with or separately from the charging cable, for example. Similarly, the refrigerant outflow passage 50B of the charging connector 50 is connected to the refrigerant suction port of the refrigerant circulation pump 60 on the infrastructure side via the refrigerant pipe that is provided together with or separately from the charging cable. A cooling circuit (not shown) is attached to the refrigerant circulation pump 60 so that the refrigerant to be discharged can be cooled.

A rechargeable battery 1 that supplies electric power to the facilities in the vehicle is mounted in the vehicle (the region A). A junction block (J/B) 2 is connected to the battery 1, and a male connector 3 is provided in the junction block 2. The male connector 3 is an example of the counterpart connector. A charging cable device 10 is provided as a device that connects the male connector 3 inside the vehicle (the region A) and the charging connector 50 outside the vehicle (the region B). The charging cable device 10 is provided in the vehicle (the region A).

The charging cable device 10 includes a cable 11, a female connector 12 that is attached to one end side of the cable 11, and a charging inlet 18 that is attached to the other end side of the cable 11.

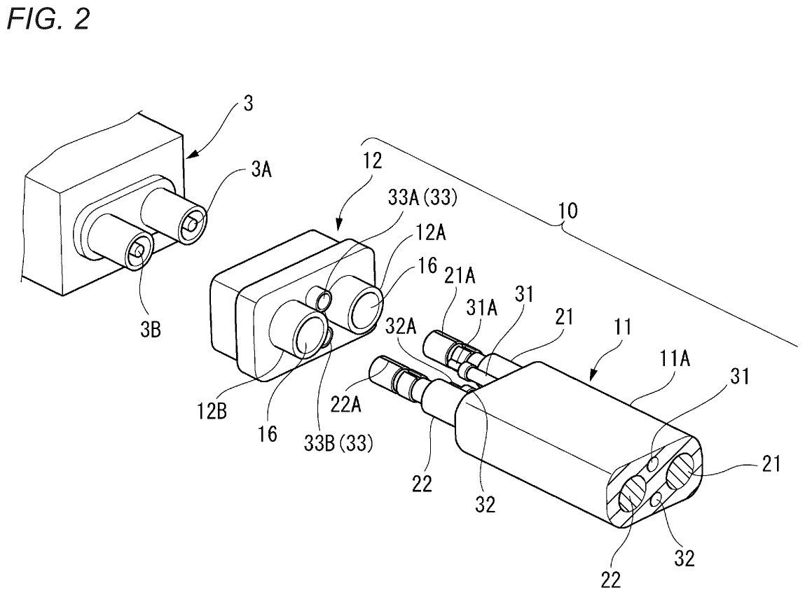

FIG. 2 shows a relationship among the end portion on one end side of the cable 11, the female connector 12 that is attached to the end portion, and the counterpart male connector 3 to which the female connector 12 is fitted and connected.

As shown in FIG. 2, inside an exterior body 11A of the cable 11, two electric wires 21 and 22 and two refrigerant flow passages 31 and 32 that extend along the electric wires 21 and 22 and that cool the electric wires 21 and 22 by a refrigerant flowing through the inside of the refrigerant flow passages 31 and 32 are provided. Although the two electric wires 21 and 22 are kept insulated from each other, the electric wires 21 and 22 are efficiently cooled by the refrigerant flowing through the refrigerant flow passages 31 and 32.

As shown in FIG. 1, since the female connector 12 that is attached to the end portion of the cable 11 is fitted and connected to the counterpart male connector 3 that is mounted on the vehicle, a U-turn connection flow path 33 is provided in the female connector 12. The U-turn connection flow path 33 is an example of the connection flow path. When the female connector 12 is attached to the end portion of the cable 11, the U-turn connection flow path 33 allows the two refrigerant flow passages 31 and 32 in the cable 11 to communicate with each other. In this way, the two refrigerant flow passages 31 and 32 in the cable 11 communicate with each other, so that the refrigerant that flows through one of the two refrigerant flow passages 31 and 32 can flow into the other. Therefore, the female connector 12 can be referred to as a high-pressure female connector for refrigerant circulation.

As described above, the female connector 12 that is fitted and connected to the male connector 3 mounted on the vehicle is attached to one end portion of the cable 11. On the other hand, the charging inlet 18 to which the charging connector 50 outside the vehicle is connected is attached to the other end portion of the cable 11. The charging connector 50 is provided at the distal end of the charging cable.

The charging inlet 18 is provided with a charging terminal (not shown) that electrically connects the electric wires 21 and 22 in the cable 11 and an electric wire (a terminal for charging of the charging connector 50) of a charging cable (not shown) outside the vehicle (the region B). The charging inlet 18 is formed with refrigerant passage connection ports 18A and 18B that respectively connect the two refrigerant flow passages 31 and 32 in the cable 11 with the two refrigerant passages (the refrigerant inflow passage 50A and the refrigerant outflow passage 50B) in the charging connector 50 outside the vehicle (the region B).

Therefore, by connecting the charging connector 50 outside the vehicle (the region B) to the charging inlet 18 inside the vehicle (the region A), the refrigerant that is discharged from the refrigerant circulation pump 60 on the infrastructure side can be circulated through the cable 11 of the charging cable device 10. An arrow R in FIG. 1 shows the direction in which the refrigerant flows.

With reference to FIG. 2, the arrangement relationship between the electric wires 21 and 22 and the refrigerant flow passages 31 and 32 in the cable 11 will be described. The two refrigerant flow passages 31 and 32 in the cable 11 are provided between the pair of electric wires 21 and 22 in the cable 11. The female connector 12 is provided with a pair of electric wire arrangement portions 12A and 12B in which the pair of electric wires 21 and 22 in the cable 11 are arranged, and the U-turn connection flow path 33 in the female connector 12 is provided between the pair of electric wire arrangement portions 12A and 12B.

Connection terminals 21A and 22A to be connected to counterpart terminals 3A and 3B of the male connector 3 are attached to the end portions of the electric wires 21 and 22 in the cable 11. The electric wire arrangement portions 12A and 12B in the female connector 12 are formed with through holes 16 for enabling the counterpart terminals 3A and 3B to be fitted and connected with the connection terminals 21A and 22A in the electric wire arrangement portions 12A and 12B. One end of the U-turn connection flow path 33 in the female connector 12 is provided with a first connection portion 33A to be connected to an end portion 31A of one refrigerant flow passage 31 in the cable 11. Further, the other end of the U-turn connection flow path 33 in the female connector 12 is provided with a second connection portion 33B to be connected to an end portion 32A of the other refrigerant flow passage 32 in the cable 11.

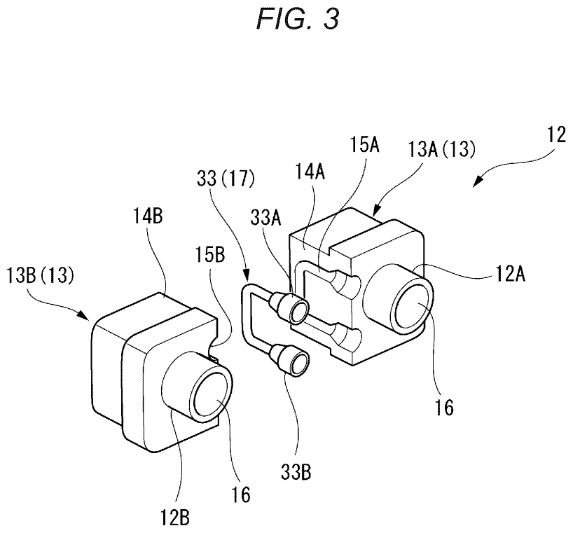

FIG. 3 is an exploded perspective view showing an example of the female connector 12.

The connector housing 13 of the female connector 12 is halved into two half bodies 13A and 13B to be combined into one by bringing mating surfaces 14A and 14B into contact with each other. One and the other of the pair of electric wire arrangement portions 12A and 12B are provided on one and the other of the half bodies 13A and 13B, respectively. The U-turn connection flow path 33 is provided between the mating surface 14A of the half body 13A and the mating surface 14B of the half body 13B.

At least one of the mating surface 14A of the half body 13A and the mating surface 14B of the half body 13B is formed with U-shaped recesses 15A and 15B, and a U-shaped pipe 17 is assembled to the recesses 15A and 15B, so that the U-turn connection flow path 33 is formed.

According to the vehicle cooling system in the present embodiment, as shown in FIG. 1, the female connector 12 that is provided on one end side of the charging cable device 10 is connected to the male connector 3, and the charging connector 50 outside the vehicle (the region B) is connected to the charging inlet 18 that is provided on the other end side of the charging cable device 10. With this configuration, as shown by the arrow R in FIG. 1, the refrigerant that is discharged from the refrigerant circulation pump 60 on the infrastructure side can be circulated through the cable 11 of the charging cable device 10.

That is, since the female connector 12 that is attached to the end portion on the one end side of the cable 11 has the U-turn connection flow path 33, the refrigerant that has passed through the one refrigerant flow passage 31 in the cable 11 flows into the other refrigerant flow passage 32 in the cable 11 through the U-turn connection flow path 33 in the female connector 12. Therefore, the refrigerant can be circulated in the cable 11. Accordingly, the electric wires 21 and 22 can be cooled by the refrigerant that flows through the refrigerant flow passages 31 and 32, and an increase in the diameter of the electric wires 21 and 22 and the cable 11 can be prevented. As a result, an increase in the weight of the cable 11 can be prevented, and the mounting space for the cable 11 can be reduced. Specifically, as shown in FIG. 1, it is possible to prevent an increase in the diameter of the cable 11, which is compatible with rapid charging and extends from the charging inlet 18.

In the present embodiment, since the refrigerant circulates between the pair of electric wires 21 and 22, the two electric wires 21 and 22 can be efficiently cooled.

In the present embodiment, since the electric wires 21 and 22 on the cable 11 side are directly connected to the counterpart terminals 3A and 3B of the male connector 3 through the through holes 16 that are formed in the electric wire arrangement portions 12A and 12B of the female connector 12, unnecessary contact conduction points can be reduced.

In the present embodiment, since the female connector 12 having the U-turn connection flow path 33 is implemented by combining the two half bodies 13A and 13B, assembly is easy.

In the present embodiment, the U-shaped pipe 17 is assembled to the U-shaped recesses 15A and 15B to form the U-turn connection flow path 33 inside the connector housing 13 of the female connector 12. This configuration facilitates injection molding of the connector housing 13 as compared with a case in which the U-turn connection flow path 33 is directly formed in the connector housing 13. Since liquid-tight treatment for the connector housing 13 is not required, the female connector 12 having the U-turn connection flow path 33 therein can be easily manufactured.

### Second Embodiment

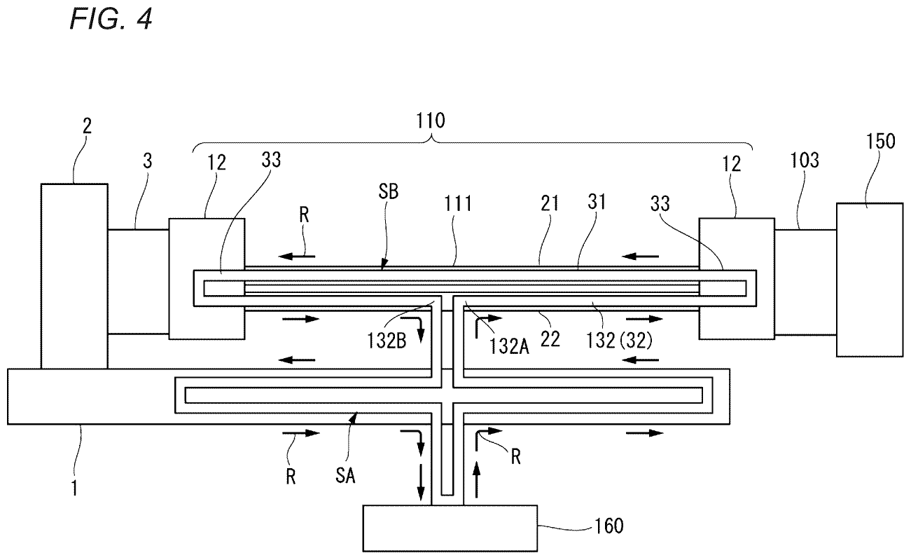

FIG. 4 is a schematic diagram showing a schematic configuration of a second embodiment of the present disclosure.

The vehicle cooling system according to this embodiment is a cooling system that is established in a vehicle, and is for cooling a motor cable 111 (hereinafter referred to as a cable 111) on a power supply passage for supplying power from the battery 1 to a high-voltage motor 150 for driving the vehicle.

As shown in FIG. 4, in the vehicle cooling system according to the present embodiment, a power supply cable device 110 is used in which the female connector 12 having the U-turn connection flow path 33 is attached to both one end side and the other end side of the cable 111.

Similarly to the first embodiment, the cable 111 of the power supply cable device 110 includes the pair of electric wires 21 and 22 and the two refrigerant flow passages 31 and 32 that extend along the electric wires 21 and 22 and that cool the electric wires 21 and 22 by the refrigerant flowing through the inside of the refrigerant flow passages 31 and 32. However, one refrigerant flow passage 32 (132) of the two refrigerant flow passages 31 and 32 in the cable 111 is blocked from communication in the middle in the length direction, and a refrigerant inflow port 132A and a refrigerant outflow port 132B are formed at the communication blocking ends on both sides of the communication blocking portion. The electric wires 21 and 22 and the refrigerant flow passages 31 and 32 (132) are provided inside the exterior body (not shown) of the cable 111 as in the first embodiment.

The power supply cable device 110 electrically connects the power supply circuit on the battery 1 side and the high-voltage motor 150 by connecting the female connector 12 on one end side to the male connector 3 on the battery 1 side and connecting the female connector 12 on the other end side to the male connector 103 on the high-voltage motor 150 side. The male connector 103 is an example of the counterpart connector. The female connector 12 having the U-turn connection flow path 33 is attached to both ends of the cable 111 in the power supply cable device 110. With this configuration, the refrigerant that is introduced from the refrigerant inflow port 132A can be circulated through the refrigerant flow passages 31 and 32 in the cable 111 to form a cable side refrigerant passage SB that leads out from the refrigerant outflow port 132B.

On the other hand, a cooling system that cools an object to be cooled mounted on the vehicle is provided in the vehicle in advance. Specific examples of the object to be cooled include the battery 1 that is a heat generating component. The cable side refrigerant passage SB of the power supply cable device 110 described above is connected in series as a part of a refrigerant circulation passage SA of the cooling system. That is, the refrigerant inflow port 132A of the cable side refrigerant passage SB is connected to the discharge side of the refrigerant circulation passage SA of the cooling system, and the refrigerant outflow port 132B of the cable side refrigerant passage SB is connected to the suction side of the refrigerant circulation passage SA of the cooling system. A refrigerant circulation pump 160 and a cooling circuit (not shown) are incorporated in the refrigerant circulation passage SA.

In this way, the cable side refrigerant passage SB is incorporated in series with the refrigerant circulation passage SA that is provided in the object to be cooled such as the in-vehicle battery 1. With this configuration, it is possible to cool the object to be cooled such as the battery 1 and the electric wires 21 and 22 of the cable 111 together in one in-vehicle cooling system by the refrigerant that circulates through the refrigerant passage in the direction of the arrow R in FIG. 4.

In particular, in the present embodiment, since the female connector 12 having the U-turn connection flow path 33 is attached to both ends of the cable 111, it is possible to unify the type of the female connector 12 that is provided in the end portion of the cable 111. Since it is not necessary to provide an internal passage more than necessary for circulating the refrigerant in the counterpart male connector 3, 103 or the like, it is possible to contribute to cost reduction.

### Third Embodiment

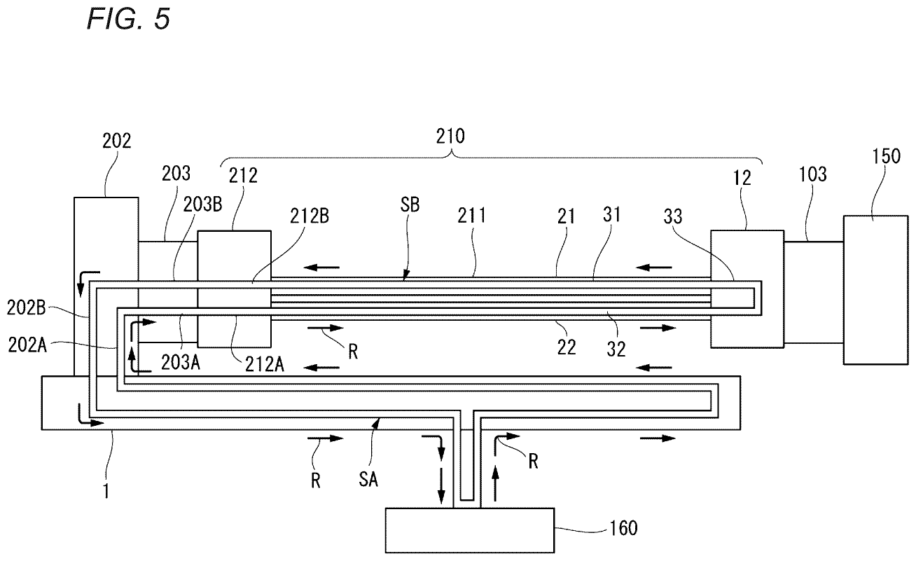

FIG. 5 is a schematic diagram showing a schematic configuration of a third embodiment of the present disclosure.

Similarly to the second embodiment, the vehicle cooling system according to this embodiment is also a cooling system that is established in a vehicle, and is for cooling a motor cable 211 (hereinafter referred to as a cable 211) on a power supply passage for supplying power from the battery 1 to the high-voltage motor 150 for driving the vehicle.

As shown in FIG. 5, in the vehicle cooling system according to the present embodiment, a power supply cable device 210 is used in which the female connector 12 having the U-turn connection flow path 33 is attached only to one end side of the cable 211. A second female connector 212 that is fitted and connected to a second counterpart male connector 203 mounted on the vehicle is attached to the other end side of the cable 211. The second female connector 212 is an example of the second connector, and the second counterpart male connector 203 is an example of the second counterpart connector. The second female connector 212 is not provided with a U-turn connection flow path, and is provided with two linear internal passages 212A and 212B.

Similarly to the first embodiment, the cable 211 of the power supply cable device 210 includes the pair of electric wires 21 and 22 and the two refrigerant flow passages 31 and 32 that extend along the electric wires 21 and 22 and that cool the electric wires 21 and 22 by the refrigerant flowing through the inside of the refrigerant flow passages 31 and 32. The second female connector 212 having the U-turn connection flow path 33 is attached only to one end side of the cable 211 that is connected to the high-voltage motor 150. The two refrigerant flow passages 31 and 32 on the other end side of the cable 211 connected to the battery 1 side are respectively connected to the two internal passages 212A and 212B of the second female connector 212.

In the power supply cable device 210, the female connector 12 on one end side is connected to the male connector 103 on the high-voltage motor 150 side, and the second female connector 212 on the other end side is connected to the second counterpart male connector 203 that is provided in the junction block 202 on the battery 1 side. In this way, the power supply cable device 210 electrically connects the power supply circuit on the battery 1 side and the high-voltage motor 150. In the power supply cable device 210, the female connector 12 having the U-turn connection flow path 33 is attached to one end portion of the cable 211. With this configuration, the refrigerant that is introduced from the one internal passage 212A of the second female connector 212 can be circulated through the refrigerant flow passages 31 and 32 in the cable 211 to form the cable side refrigerant passage SB that leads out from the other internal passage 212B. That is, the one internal passage 212A of the second female connector 212 serves as the refrigerant inflow port of the cable side refrigerant passage SB, and the other internal passage 212B serves as the refrigerant outflow port of the cable side refrigerant passage SB.

On the other hand, as in the second embodiment, a cooling system that cools an object to be cooled such as the battery 1 mounted on the vehicle is provided in the vehicle in advance. The cable side refrigerant passage SB of the power supply cable device 110 described above is connected in series as a part of the refrigerant circulation passage SA of the cooling system. That is, the refrigerant inflow port (the one internal passage 212A of the second female connector 212) of the cable side refrigerant passage SB is connected to the discharge side of the refrigerant circulation passage SA of the cooling system via one internal passage 203A of the second counterpart male connector 203 on the battery 1 side and one internal passage 202A of the junction block 202. The refrigerant outflow port (the other internal passage 212B of the second female connector 212) of the cable side refrigerant passage SB is connected to the suction side of the refrigerant circulation passage SA of the cooling system via the other internal passage 203B of the second counterpart male connector 203 and the other internal passage 202B of the junction block 202. As in the second embodiment, the refrigerant circulation pump 160 and a cooling circuit (not shown) are incorporated in the refrigerant circulation passage SA.

In this way, in the third embodiment, similarly to the second embodiment, the cable side refrigerant passage SB is incorporated in series with the refrigerant circulation passage SA that is provided in the object to be cooled such as the in-vehicle battery 1. With this configuration, it is possible to cool the object to be cooled (such as the battery 1) and the electric wires 21 and 22 of the cable 211 together in one in-vehicle cooling system by the refrigerant that circulates through the refrigerant passage in the direction of the arrow R in FIG. 5.

In particular, in the present embodiment, the refrigerant is circulated in the cable 211 through the second female connector 212 that is attached to the other end side of the cable 211, and through the internal passages 203A, 203B, 202A, and 202B of the second counterpart male connector 203 and the junction block 202 to which the second female connector 212 are fitted and connected. Therefore, the refrigerant circulation passage can be simplified.

Here, the features of the vehicle cooling system according to the embodiments of the present disclosure described above are briefly summarized and listed in the following [1] to [9].
[1] A vehicle cooling system including:
a cable (11, 111, 211) including an electric wire (21, 22) and two refrigerant flow passages (31, 32) that extend along the electric wire and that are for cooling the electric wire by a refrigerant flowing through an inside of the two refrigerant flow passages; and
a connector (a female connector 12) that is attached to an end portion of the cable and that is fitted and connected to a counterpart connector (a male connector 3) mounted on a vehicle,
in which the connector is provided with a connection flow path (a U-turn connection flow path 33) that causes, by causing the two refrigerant flow passages of the cable to communicate with each other, the refrigerant flowing through one of the two refrigerant flow passages to flow into the other, and
a cable side refrigerant passage that is implemented by the two refrigerant flow passages (31, 32) in the cable (11) and the connection flow path (the U-turn connection flow path 33) in the connector (the female connector 12) is provided inside the vehicle.

According to the configuration [1] described above, since the connector attached to the end portion of the cable has the connection flow path, the refrigerant that flows through the one refrigerant flow passage in the cable can flow into the other refrigerant flow passage in the cable through the connection flow path in the connector. That is, by making a U-turn of the refrigerant at the connector, the refrigerant can be circulated in the cable, and the electric wire can be cooled by the refrigerant that flows through the refrigerant flow passage. Therefore, the refrigerant can be circulated on the vehicle side by the refrigerant circulation pump provided outside or inside the vehicle to cool the electric wire routed inside the vehicle, thereby preventing an increase in the diameter of the electric wire. As a result, an increase in the weight of the cable can be prevented, and the mounting space for the cable can be reduced.
[2] The vehicle cooling system according to [1] described above,
in which the connector (the female connector 12) to be fitted and connected to a counterpart connector (a male connector 3) mounted on a vehicle is attached to one end portion of the cable (11), and a charging inlet (18) to which a charging cable outside the vehicle is to be connected is attached to the other end portion, and
in which the charging inlet is provided with a charging terminal configured to electrically connect an electric wire of the cable and an electric wire of the charging cable outside the vehicle, and refrigerant passage connection ports (18A, 18B) that respectively connect two refrigerant flow passages of the cable and two refrigerant passages (a refrigerant inflow passage 50A and a refrigerant outflow passage 50B) outside the vehicle.

With the configuration [2] described above, it is possible to prevent an increase in the diameter of the cable, which is compatible with rapid charging and extends from the charging inlet.
[3] The vehicle cooling system according to [1] or [2] described above,
in which the two refrigerant flow passages (31, 32) in the cable (11) are provided between the pair of electric wires (21, 22) in the cable,
in which the connector (the female connector 12) is provided with a pair of electric wire arrangement portions (12A, 12B) in which the pair of electric wires are provided, and
in which the connection flow path (the U-turn connection flow path 33) in the connector is provided between the pair of electric wire arrangement portions.

With the configuration [3] described above, since the refrigerant circulates between the pair of electric wires, the electric wires can be efficiently cooled.
[4] A vehicle cooling system including,
a cable (11, 111, 211) including an electric wire (21, 22) and two refrigerant flow passages (31, 32) that extend along the electric wire and that are for cooling the electric wire by a refrigerant flowing through an inside of the two refrigerant flow passages; and
a connector (a female connector 12) that is attached to an end portion of the cable and that is fitted and connected to a counterpart connector (a male connector 3) mounted on a vehicle,
in which the connector is provided with a connection flow path (a U-turn connection flow path 33) that causes, by causing the two refrigerant flow passages of the cable to communicate with each other, the refrigerant flowing through one of the two refrigerant flow passages to flow into the other,
in which the two refrigerant flow passages (31, 32) in the cable (11) are provided between the pair of electric wires (21, 22) in the cable,
   in which the connector (the female connector 12) is provided with a pair of electric wire arrangement portions (12A, 12B) in which the pair of electric wires are provided,
   in which the connection flow path (the U-turn connection flow path 33) in the connector is provided between the pair of electric wire arrangement portions, and
in which a housing (a connector housing 13) of the connector (the female connector 12) is halved into two half bodies (13A, 13B) to be combined into one by bringing mating surfaces (14A, 14B) into contact with each other, one and the other of the pair of electric wire arrangement portions are respectively provided in one and the other of the two half bodies, and the connection flow path (33) is formed between the mating surfaces.

According to the configuration [4] described above, since the connector housing having the connection flow path can be implemented by combining the two half bodies, assembly is easy.
[5] The vehicle cooling system according to [4] described above,
in which a U-shaped recess (15A, 15B) is formed in at least one of the mating surfaces (14A, 14B) of the two half bodies (13A, 13B), and a U-shaped pipe (17) that forms the connection flow path (33) is assembled in the recess.

With the configuration [5] described above, by assembling the U-shaped pipe in the U-shaped recess, the U-turn connection flow path can be formed inside the housing of the connector. This facilitates injection molding of the connector housing as compared with a case in which the U-turn connection flow path is directly formed in the connector housing. Since liquid-tight treatment for the connector housing is not required, the connector having the U-turn connection flow path can be easily manufactured.
[6] A vehicle cooling system including,
a cable (11, 111, 211) including an electric wire (21, 22) and two refrigerant flow passages (31, 32) that extend along the electric wire and that are for cooling the electric wire by a refrigerant flowing through an inside of the two refrigerant flow passages; and
   a connector (a female connector 12) that is attached to an end portion of the cable and that is fitted and connected to a counterpart connector (a male connector 3) mounted on a vehicle,
   in which the connector is provided with a connection flow path (a U-turn connection flow path 33) that causes, by causing the two refrigerant flow passages of the cable to communicate with each other, the refrigerant flowing through one of the two refrigerant flow passages to flow into the other,
   in which a connection terminal (21A, 22A) to be connected to a counterpart terminal (3A, 3B) of the counterpart connector (the male connector 3) is attached to an end portion of the electric wire (21, 22) in the cable (11),
   in which a through hole (16) for enabling the counterpart terminal to be fitted and connected with the connection terminal is formed in an electric wire arrangement portion (12A, 12B) in the connector, and
   in which a first connection portion (33A) to be connected to one of the refrigerant flow passages (31) in the cable (11) is provided at one end of the connection flow path (the U-turn connection flow path 33) in the connector, and a second connection portion (33B) to be connected to the other of the refrigerant flow passages (32) in the cable is provided at the other end of the connection flow path in the connector.

With the configuration [6] described above, since the electric wire on the cable side is directly connected to the terminal of the counterpart connector through the through hole that is formed in the electric wire arrangement portion of the connector, unnecessary contact conduction points can be reduced.
[7] The vehicle cooling system according to [1] described above,
in which a cable side refrigerant passage that is implemented by the two refrigerant flow passages (31, 32) in the cable (11) and the connection flow path (the U-turn connection flow path 33) in the connector (the female connector 12) is provided inside the vehicle and incorporated as a part of a refrigerant circulation passage for cooling an object to be cooled (a battery 1) mounted on the vehicle.

With the configuration [7] described above, since the cable side refrigerant passage is incorporated in the refrigerant circulation passage that is provided in the object to be cooled such as the in-vehicle battery, the object to be cooled and the electric wire of the cable can be cooled together.
[8] The vehicle cooling system according to [7] described above,
in which the connector (the female connector 12) having the connection flow path is attached to both one end side and the other end side of the cable,
in which one of the two refrigerant flow passages in the cable (111) is blocked from communication in a middle in a length direction, and a refrigerant inflow port (132A) and a refrigerant outflow port (132B) are formed at communication blocking ends on both sides of a communication blocking portion, and
in which the refrigerant flow passage in the cable is connected in series with a refrigerant circulation passage (SA) in the vehicle by the refrigerant inflow port and the refrigerant outflow port.

With the configuration [8] described above, since the connector having the U-turn connection flow path is attached to both ends of the cable, it is possible to unify the type of the female connector that is provided in the end portion of the cable. Since it is not necessary to provide an internal passage more than necessary for circulating the refrigerant in the counterpart connector or the like, it is possible to contribute to cost reduction.
[9] The vehicle cooling system according to [7] described above,
in which the connector having the connection flow path is attached only to one end side of the cable (211), a second connector (a second female connector 212) to be fitted and connected to a second counterpart connector (a second counterpart male connector 203) mounted on a vehicle is attached to the other end side of the cable, and
in which end portions of the two refrigerant flow passages on the other end side of the cable are connected to a refrigerant circulation passage (SA) in the vehicle through the second connector that is attached to the other end side of the cable and an internal passage of the second counterpart connector.

According to the configuration [9] described above, since the refrigerant is circulated in the cable through the second connector that is attached to the other end side of the cable and the internal passage of the second counterpart connector to which the second connector is fitted and connected, the refrigerant circulation passage can be simplified.

The present application is based on a Japanese patent application (Japanese Patent Application No. 2023-013268) filed on Jan. 31, 2023, and the contents thereof are incorporated herein by reference.

### INDUSTRIAL APPLICABILITY

According to the present disclosure, it is possible to provide a vehicle cooling system capable of minimizing an increase in the diameter of a cable associated with an increase in the output of an electric vehicle. The present disclosure having this effect is useful for a vehicle cooling system of an electric vehicle or the like.

1. A vehicle cooling system comprising:
a cable including an electric wire and two refrigerant flow passages, the two refrigerant flow passages extending along the electric wire and cooling the electric wire by a refrigerant flowing through an inside of the two refrigerant flow passages; and
a connector that is attached to an end portion of the cable and that is fitted and connected to a counterpart connector mounted on a vehicle,
wherein the connector is provided with a connection flow path that causes, by causing the two refrigerant flow passages of the cable to communicate with each other, the refrigerant flowing through one of the two refrigerant flow passages to flow into another of the two refrigerant flow passages, and
wherein a cable side refrigerant passage that is implemented by the two refrigerant flow passages in the cable and the connection flow path in the connector is arranged inside the vehicle.

2. The vehicle cooling system according to claim 1,
wherein the connector to be fitted and connected to a counterpart connector mounted on a vehicle is attached to one end portion of the cable, and a charging inlet to which a charging cable outside the vehicle is to be connected is attached to another end portion of the cable, and
wherein the charging inlet is provided with a charging terminal configured to electrically connect the electric wire of the cable and an electric wire of the charging cable outside the vehicle, and refrigerant passage connection ports that respectively connect the two refrigerant flow passages of the cable and two refrigerant passages outside the vehicle.

3. The vehicle cooling system according to claim 1,
wherein the two refrigerant flow passages in the cable are arranged between a pair of the electric wires in the cable,
wherein the connector is provided with a pair of electric wire arrangement portions in which the pair of electric wires are arranged, and
wherein the connection flow path in the connector is arranged between the pair of electric wire arrangement portions.

4. A vehicle cooling system comprising:
a cable including an electric wire and two refrigerant flow passages, the two refrigerant flow passages extending along the electric wire and cooling the electric wire by a refrigerant flowing through an inside of the two refrigerant flow passages; and
a connector that is attached to an end portion of the cable and that is fitted and connected to a counterpart connector mounted on a vehicle,
wherein the connector is provided with a connection flow path that causes, by causing the two refrigerant flow passages of the cable to communicate with each other, the refrigerant flowing through one of the two refrigerant flow passages to flow into another of the two refrigerant flow passages,
wherein the two refrigerant flow passages in the cable are arranged between a pair of the electric wires in the cable,
wherein the connector is provided with a pair of electric wire arrangement portions in which the pair of electric wires are arranged,
wherein the connection flow path in the connector is arranged between the pair of electric wire arrangement portions, and
wherein a housing of the connector is halved into two half bodies to be combined into one by fitting mating surfaces into contact with each other, one and the other of the pair of electric wire arrangement portions are respectively provided in one and the other of the two half bodies, and the connection flow path is formed between the mating surfaces.

5. The vehicle cooling system according to claim 4,
wherein a U-shaped recess is formed in at least one of the mating surfaces of the two half bodies, and a U-shaped pipe that forms the connection flow path is assembled in the recess.

6. A vehicle cooling system comprising:
a cable including an electric wire and two refrigerant flow passages, the two refrigerant flow passages extending along the electric wire and cooling the electric wire by a refrigerant flowing through an inside of the two refrigerant flow passages; and
a connector that is attached to an end portion of the cable and that is fitted and connected to a counterpart connector mounted on a vehicle,
wherein the connector is provided with a connection flow path that causes, by causing the two refrigerant flow passages of the cable to communicate with each other, the refrigerant flowing through one of the two refrigerant flow passages to flow into another of the two refrigerant flow passages,
wherein a connection terminal to be connected to a counterpart terminal of the counterpart connector is attached to an end portion of the electric wire in the cable,
wherein a through hole for enabling the counterpart terminal to be fitted and connected with the connection terminal is formed in an electric wire arrangement portion in the connector, and
wherein a first connection portion to be connected to one of the refrigerant flow passages in the cable is provided at one end of the connection flow path in the connector, and a second connection portion to be connected to the other of the refrigerant flow passages in the cable is provided at another end of the connection flow path in the connector.

7. The vehicle cooling system according to claim 1,
wherein the cable side refrigerant passage is incorporated as a part of a refrigerant circulation passage for cooling a cooled object mounted on the vehicle.

8. The vehicle cooling system according to claim 7,
wherein the connector having the connection flow path is attached to both sides of the cable,
wherein one of the two refrigerant flow passages in the cable is blocked from communication in a middle in a length direction, and a refrigerant inflow port and a refrigerant outflow port are formed at communication blocking ends on both sides of a communication blocking portion, and
wherein the refrigerant flow passage in the cable is connected in series with a refrigerant circulation passage in the vehicle by the refrigerant inflow port and the refrigerant outflow port.

9. The vehicle cooling system according to claim 7,
wherein the connector having the connection flow path is attached only to one side of the cable, a second connector to be fitted and connected to a second counterpart connector mounted on a vehicle is attached to another side of the cable, and
wherein end portions of the two refrigerant flow passages on the other side of the cable are connected to a refrigerant circulation passage in the vehicle through the second connector that is attached to the other side of the cable and an internal passage of the second counterpart connector.
